(19) United States
(12) Patent Application Publication
(10) Pub. No.: US 2018/0334119 A1
(43) Pub. Date: Nov. 22, 2018

(54) WORK VEHICLE

(71) Applicant: Komatsu Ltd., Tokyo (JP)

(72) Inventor: Hirofumi Miyamoto, Tokyo (JP)

(21) Appl. No.: 15/518,328

(22) PCT Filed: Dec. 27, 2016
(86) PCT No.: PCT/JP2016/088870

§ 371 Date: Apr. 11, 2017

(51) Int. Cl. B60R 16/04; E02F 9/08

(52) U.S. Cl. CPC B60R 16/04; B62D 25/12; E02F 9/0891

(57) ABSTRACT

A work vehicle is provided with a vehicle main body, an exterior plate which covers a part of the vehicle main body, an accommodating unit arranged around the exterior plate of the vehicle main body, a lid portion configured to close an inner space of the accommodating unit, and an opening/closing mechanism which couples the accommodating unit to the lid portion and is located on a side of an exterior plate to open/close the lid portion, wherein a first space is formed above an end on the side of the exterior plate of the lid portion and below the exterior plate in a state in which the lid portion opens.

### FIELD

The present invention relates to a work vehicle.

### BACKGROUND

A work vehicle in which a battery box is arranged on a rear portion of a vehicle main body is known (for example, refer to Patent Literature 1). The battery box includes an accommodating unit which accommodates a battery therein and a lid portion which covers the accommodating unit. A vehicle main body side of the lid portion of the battery box is coupled to the accommodating unit by means of a hinge and the like, for example. In this case, the battery box has a configuration opened when the lid portion is lifted toward the vehicle main body.

### CITATION LIST

### Patent Literature

Patent Literature 1: Japanese Laid-open Patent Publication No. 2012-183943

### SUMMARY

### Technical Problem

In the work vehicle having the above-described configuration, the lid portion is opened for checking a liquid surface of electrolytic solution and a state of a terminal of the battery at the time of checkup and the like, but the lid portion is normally closed. For example, when the work vehicle stops at night and the like, if snow falls in a state in which the lid portion of the battery box is closed to be unattended for a long time, the snow might pile on the lid portion or sediment and the like in a site of work is deposited on the lid portion. For example, when the lid portion is opened with the snow piled thereon, the snow is sandwiched between the lid portion and an exterior plate of the vehicle main body and cannot escape anywhere. Therefore, there is a case where the lid portion cannot be sufficiently opened.

The present invention is achieved in view of the above, and an object thereof is to provide the work vehicle capable of surely opening the lid portion of the accommodating unit provided on the vehicle main body.

### Solution to Problem

According to a first aspect of the present invention, a work vehicle, comprises: a vehicle main body; an exterior plate which covers a part of the vehicle main body; an accommodating unit arranged around the exterior plate of the vehicle main body; a lid portion configured to close an inner space of the accommodating unit; and an opening/closing mechanism which couples the accommodating unit to the lid portion and is located on a side of an exterior plate to open/close the lid portion, wherein a first space is formed above an end on the side of the exterior plate of the lid portion and below the exterior plate in a state in which the lid portion opens.

### Advantageous Effects of Invention

According to an aspect of the present invention, it is possible to provide a work vehicle capable of surely opening a lid portion of an accommodating unit provided on a vehicle main body.

### BRIEF DESCRIPTION OF DRAWINGS

FIG. 1 is a perspective view illustrating an example of a work vehicle according to this embodiment.

FIG. 2 is a perspective view illustrating an example of a rear portion of a vehicle main body.

FIG. 3 is a perspective view illustrating an example of the rear portion of the vehicle main body.

FIG. 4 is a perspective view schematically illustrating an example of a box unit.

FIG. 5 is a side view schematically illustrating an example of the box unit.

FIG. 6 is a side view schematically illustrating an example of the box unit.

FIG. 7 is a perspective view illustrating an inner configuration of an accommodating unit.

FIG. 8 is a perspective view illustrating the inner configuration of the accommodating unit.

FIG. 9 is a view illustrating an example of an exterior plate and a box unit provided on a work vehicle according to a comparative example.

FIG. 10 is a perspective view illustrating an example of a box unit according to a variation.

FIG. 11 is a side view illustrating an example of a box unit according to a variation.

FIG. 12 is a side view illustrating an example of the box unit according to the variation.

### DESCRIPTION OF EMBODIMENTS

An embodiment according to the present invention is hereinafter described with reference to the drawings. Meanwhile, the present invention is not limited by the embodiment. Components in the following embodiment include the component which a person skilled in the art may easily replace or a substantially identical component. The components of the following embodiment may be appropriately combined with each other, and there also is a case where some components are not used.

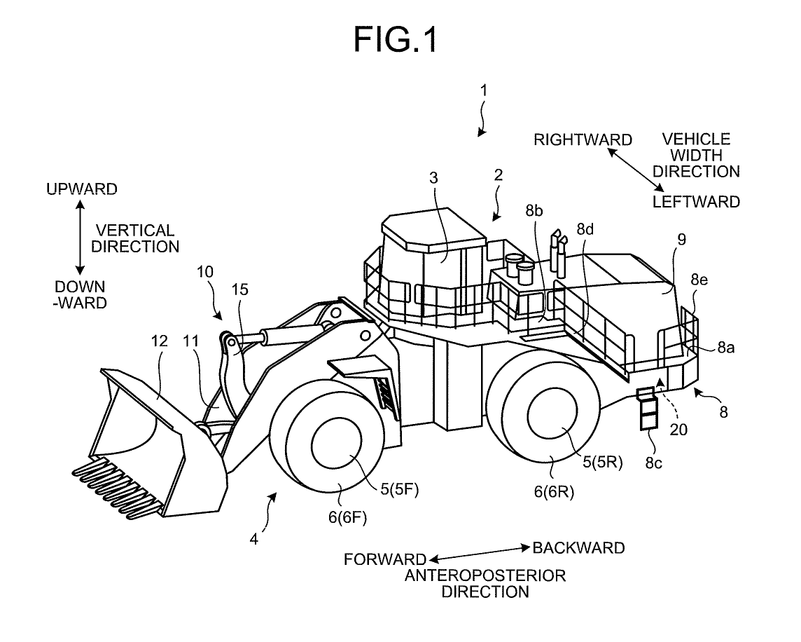

FIG. 1 is a perspective view illustrating an example of a work vehicle 1 according to this embodiment. As illustrated in FIG. 1, the work vehicle 1 is a wheel loader, for example, in this embodiment. Meanwhile, the work vehicle 1 is not limited to the wheel loader and this may also be another type of work vehicle such as a grader.

The work vehicle 1 is provided with a vehicle main body 2 and a working machine 10 supported by the vehicle main body. The vehicle main body 2 includes a driver's cabin 3, a travel device 4, an engine (not illustrated) which generates power for driving the travel device 4, and a vehicle body frame 8. The work vehicle 1 is operated by a driver getting in the driver's cabin 3. In the driver's cabin 3, a driving operation device operated by the driver is arranged. The driving operation device includes a transmission shift lever, an accelerator pedal, a brake pedal, and a working machine lever for operating the working machine 10, for example. The driver adjusts a traveling speed of the work vehicle 1, switches between forward movement and backward movement, and operates the working machine 10 by operating the driving operation device.

The travel device 4 includes rotatable wheels 5. A tire 6 is mounted on the wheel 5. The wheels 5 include two front wheels 5F and two rear wheels 5R. The tires 6 include front tires 6F mounted on the front wheels 5F and rear tires 6R mounted on the rear wheels 5R. The travel device 4 may travel on the ground.

The vehicle body frame 8 includes a lower deck 8a and an upper deck 8b. The lower deck 8a is attached to the side of a rear portion of the vehicle body frame 8. A box unit 20 to be described later is arranged below the lower deck 8a. The upper deck 8b is arranged in front of and above the lower deck 8a. A ladder 8c is arranged, for example, below the lower deck 8a. An oblique ladder 8d is arranged between the lower deck 8a and the upper deck 8b. A fence-shaped handrail 8e is arranged to the side of the lower deck 8a, the upper deck 8b, and the oblique ladder 8d.

The vehicle body frame 8 includes an exterior plate 9. The exterior plate 9 is arranged so as to cover a part of the vehicle main body 2, for example, the engine not illustrated and the like. The exterior plate 9 is arranged in a portion facing the lower deck 8a, a portion facing the upper deck 8b, and a portion facing the oblique ladder 8d, for example. The exterior plate 9 facing the lower deck 8a includes a portion facing a rear portion of the vehicle main body 2 and a portion facing a side portion (left and right portions) of the vehicle main body 2.

The working machine 10 includes a boom 11 movably coupled to the vehicle main body 2, a bucket 12 being an excavating member movably coupled to the boom 11, and a bell crank 15 coupled to the bucket 12 through a link. The working machine 10 includes a boom cylinder which drives the boom 11 and a bucket cylinder which drives the bucket 12. One end of the boom cylinder is coupled to the vehicle main body 2 and the other end thereof is coupled to the boom 11. When the driver operates the working machine lever, the boom cylinder is extended/contracted. According to this, the boom 11 moves upward and downward. One end of the bucket cylinder is coupled to the vehicle main body 2 and the other end thereof is coupled to the bell crank 15. When the driver operates the working machine lever, the bucket cylinder is extended/contracted. According to this, the bucket 12 moves upward and downward. The bucket 12 moves in front of the vehicle main body 2.

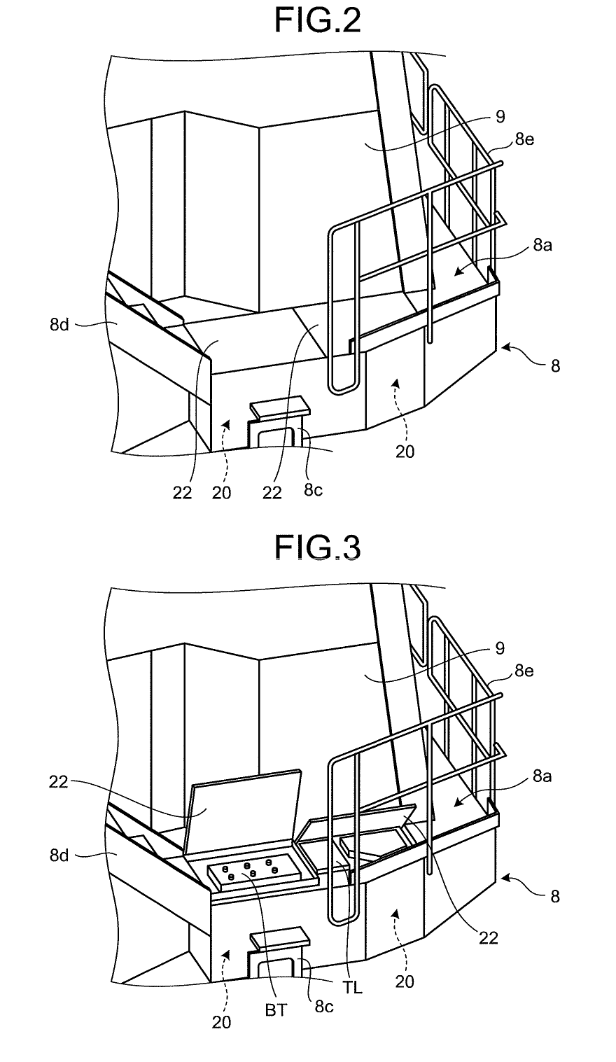

FIGS. 2 and 3 are perspective views illustrating an example of the rear portion of the vehicle main body 2. As illustrated in FIGS. 2 and 3, some of floor panels of the lower deck 8a are provided so as to be opened/closed. In this embodiment, two floor panels of the lower deck 8a may be opened/closed. The box unit 20 is arranged on the lower deck 8a. The box unit 20 may accommodate goods therein. In this embodiment, the box unit 20 includes a battery box, a tool box, a fuse box or the like, for example. Although a configuration in which the box unit 20 is arranged on the lower deck 8a facing a side portion of the exterior plate 9 is described as an example in this embodiment, the configuration is not limited thereto. For example, the box unit 20 may be arranged on the lower deck 8a facing a rear portion of the exterior plate 9.

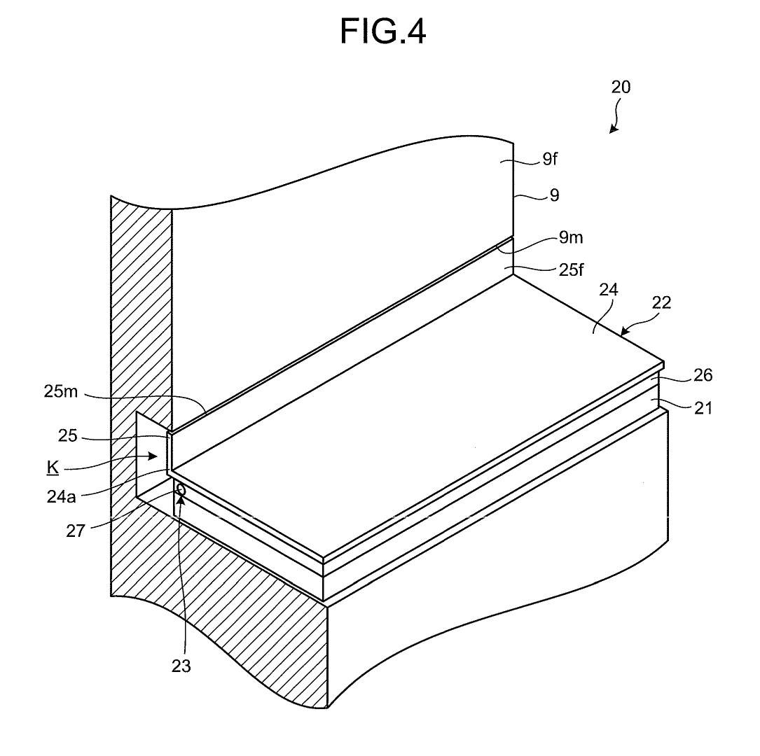

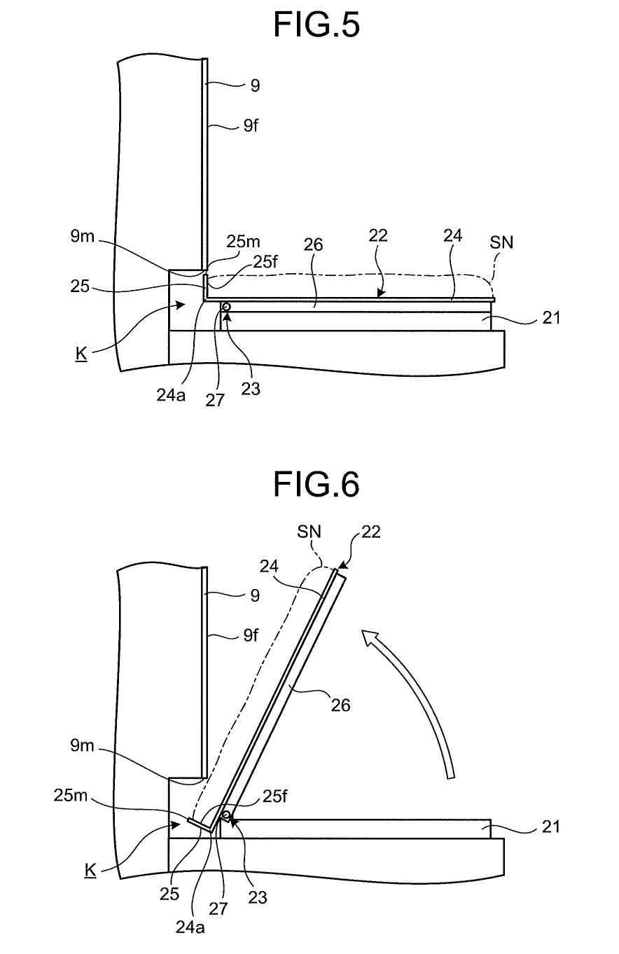

FIG. 4 is a perspective view schematically illustrating an example of the box unit 20. FIGS. 5 and 6 are side views schematically illustrating an example of the box unit 20. The box unit 20 includes an accommodating unit 21, a lid portion 22, and an opening/closing mechanism 23. The accommodating unit 21 includes an opening on an upper end thereof and includes an accommodating room therein. The accommodating unit 21 accommodates goods such as a battery BT and a tool TL in the accommodating room.

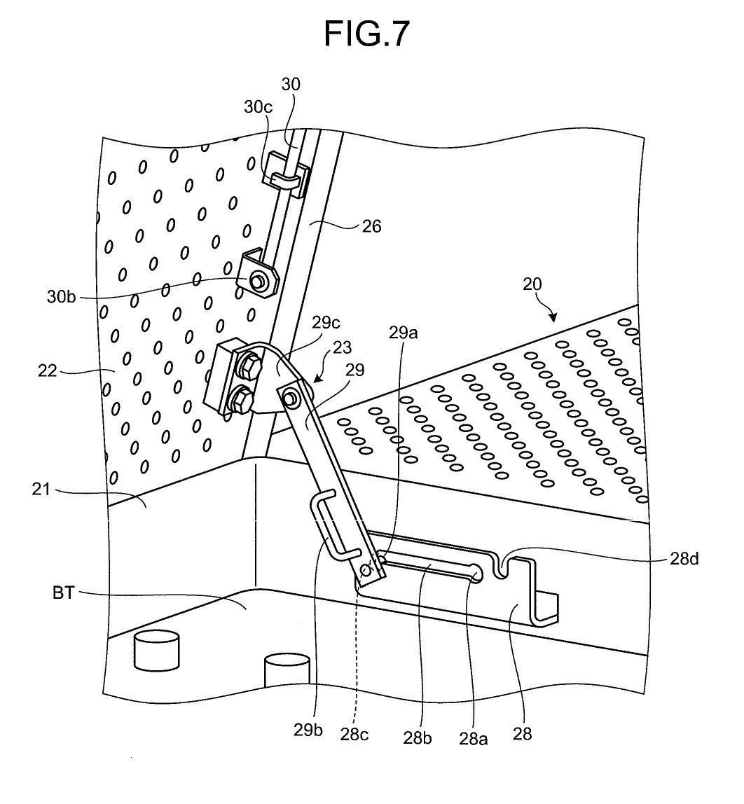

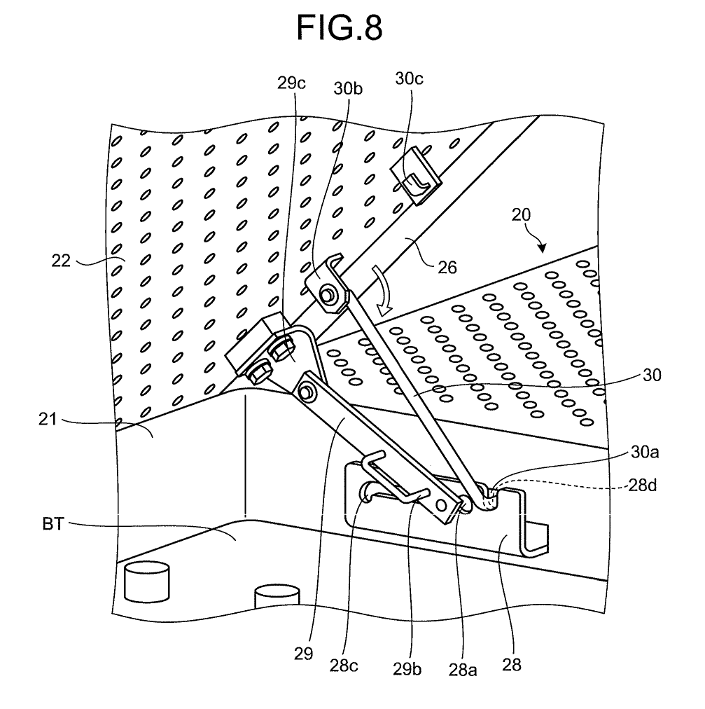

The lid portion 22 being a lid for closing the opening being a part of an inner space of the accommodating unit 21 is provided on the accommodating unit 21 so as to be opened/closed. The lid portion 22 includes a plate shape portion 24, an extending portion 25, and an attaching margin 26. In a state in which the lid portion 22 closes, the plate shape portion 24 closes the opening of the accommodating unit 21 and is used as the floor panel of the above-described lower deck 8a. Therefore, in the state in which the lid portion 22 closes, a worker and the like may pass on an upper surface of the plate shape portion 24. The plate shape portion 24 is formed of a plate shape member such as a checkered steel plate, for example. In this case, the plate shape portion 24 is configured such that the worker may easily pass on the same with a circular slip resistance portion (refer to FIGS. 7 and 8) provided on the upper surface thereof.

The extending portion 25 is arranged on an end 24a on an exterior plate 9 side of the plate shape portion 24 so as to extend upward. The extending portion 25 extends so as to be curved or bent above from the end 24a of the plate shape portion 24. The extending portion 25 is formed into a band shape in an anteroposterior direction of the vehicle main body 2, for example, to be arranged across both ends in the anteroposterior direction of the vehicle main body 2. An outer surface 25f facing the plate shape portion 24 of the extending portion 25 is flush with an outer surface 9f of the exterior plate 9, for example. That is to say, in the state in which the lid portion 22 closes, the outer surface 9f of the exterior plate 9 and the outer surface 25F of the extending portion 25 form a continuous surface without a step.

The extending portion 25 is arranged such that an upper end 25m thereof is opposed to a lower end 9m of the exterior plate 9 adjacent to the above-described lower deck 8a in the state in which the lid portion 22 closes. A slight gap is formed on the extending portion 25 in a state in which the upper end 25m is opposed to the lower end 9m of the exterior plate 9. The gap is set to a gap which is not noticeable when the worker and the like observes the same from outside. Furthermore, a space K is formed below the exterior plate 9. The space K is closed by the extending portion 25 in the state in which the lid portion 22 closes.

The attaching margin 26 is arranged on a lower surface side of the plate shape portion 24. The attaching margin 26 is a portion coupled to a hinge portion 27 to be described later. The attaching margin 26 is formed into a band shape, for example, to be arranged to form a rectangular annular shape along an outer periphery of the plate shape portion 24. The attaching margin 26 is formed to have a dimension corresponding to the accommodating unit 21 to be arranged on an inner side of the outer periphery of the plate shape portion 24, for example.

The opening/closing mechanism 23 includes the hinge portion 27. The hinge portion 27 couples the accommodating unit 21 to the attaching margin 26 of the lid portion 22. The hinge portion 27 is coupled to an end on an exterior plate 9 side of the attaching margin 26, for example. According to this configuration, the lid portion 22 is opened toward the exterior plate 9 about the hinge portion 27 when an end thereof on a side opposite to the exterior plate 9 is lifted. That is to say, the end of the lid portion 22 is moved from an outer side to an inner side of the work vehicle 1 while the end is lifted.

FIGS. 7 and 8 are perspective views illustrating an inner configuration of the accommodating unit 21. As illustrated in FIGS. 7 and 8, the opening/closing mechanism 23 includes a supporting member 28, a first supporting bar 29, and a second supporting bar 30 in the accommodating unit 21. The supporting member 28 is fixed to a side wall forming a part of an inner surface of the accommodating unit 21. The supporting member 28 supports the lid portion 22 through the first and second supporting bars 29 and 30. The supporting member 28 having a plate shape, for example, includes a standard locking unit 28a, a guiding unit 28b, a first supporting unit 28c, and a second supporting unit 28d. The standard locking unit 28a, the guiding unit 28b, and the first supporting unit 28c being through holes penetrating the supporting member 28 are provided so as to be communicated with one another. The standard locking unit 28a having a circular shape, for example, locks a projection 29a of the first supporting bar 29 in the state in which the lid portion 22 closes. The guiding unit 28b linearly extends from the standard locking unit 28a toward the exterior plate 9. The guiding unit 28b guides the projection 29a when the lid portion 22 is going to be opened or closed. The first supporting unit 28c is provided in a state in which an end on an exterior plate 9 side of the guiding unit 28b is bent downward, for example. The first supporting unit 28c locks the first supporting bar 29 when an opening amount of the lid portion 22 is a first opening amount. The second supporting unit 28d is arranged on a side opposite to the exterior plate 9 across the standard locking unit 28a, that is to say, on an outer side of the work vehicle 1 than the standard locking unit 28a, for example. The second supporting unit 28d has a shape obtained by cutting out a part of an upper side of the supporting member 28. The second supporting unit 28d locks a projection 30a of the second supporting bar 30 when the opening amount of the lid portion 22 is a second opening amount smaller than the first opening amount. In this embodiment, the first opening amount is the opening amount when the lid portion 22 is fully opened (refer to FIG. 7) and the second opening amount is the opening amount when the lid portion 22 is halfway opened (refer to FIG. 8), for example. The first and second opening amounts are not limited thereto.

Furthermore, the supporting member 28 penetrates the side wall of the accommodating unit 21 so as to extend over the box unit 20 arranged adjacent to and behind the same in the anteroposterior direction of the vehicle main body 2, for example. The supporting member 28 has a configuration similar to that described above in the accommodating unit 21 of the box unit 20 adjacent to the same. Meanwhile, the configuration of the supporting member 28 is not limited to that extending over the adjacent box units 20; this may also be separately provided on each box unit 20.

The first supporting bar 29 has a rectangular plate shape, for example. One end side of the first supporting bar 29 is coupled to the lid portion 22 by means of a coupling member 29c. The first supporting bar 29 is rotatable about the coupling member 29c. The first supporting bar 29 includes the above-described projection 29a and a grasping portion 29b which the worker may grasp. The projection 29a is arranged on the other end side of the first supporting bar 29. The projection 29a projects from the first supporting bar 29 toward the rear portion of the vehicle main body 2. The projection 29a is inserted into the through hole forming the above-described standard locking unit 28a, the guiding unit 28b, and the first supporting unit 28c. The first supporting bar 29 rotates about the coupling member 29c by opening/closing of the lid portion 22 such that the projection 29a may reciprocate among the standard locking unit 28a, the guiding unit 28b, and the first supporting unit 28c. When the projection 29a of the first supporting bar 29 is locked by the first supporting unit 28c, a weight of the lid portion 22 is supported by the first supporting bar 29 and the supporting member 28. Therefore, the opening amount of the lid portion 22 is fixed to the first opening amount.

The grasping portion 29b is formed of a first linear portion and second linear portions bent from both ends of the first linear portion by bending both ends of a round bar having a predetermined length, for example. An end of the second linear portion located in a position opposite to a connecting portion between the first and second linear portions is joined to the first supporting bar 29 by welding and the like. The worker may grasp the first supporting bar 29 to move by putting his/her hand in a space formed between the first linear portion and the first supporting bar 29. For example, when the projection 29a is locked by the first supporting unit 28c and the opening amount of the lid portion 22 is maintained to be the first opening amount, the worker grasps the grasping portion 29b to detach the projection 29a from the first supporting unit 28c and moves the same toward the guiding unit 28b, and according to this, the projection 29a may slide on the guiding unit 28b. Therefore, it is possible to change the opening amount of the lid portion 22.

The second supporting bar 30 is provided separately from the first supporting bar 29. The second supporting bar 30 has a round bar shape, for example. A base end being one end of the second supporting bar 30 is bent to be coupled to the lid portion 22 through a coupling member 30b. The second supporting bar 30 is rotatable about the coupling member 30b. Furthermore, a tip end being the other end of the second supporting bar 30 is bent in a direction opposite to that of the base end to form the above-described protrusion 30a (refer to FIG. 8).

A tip end side of the second supporting bar 30 may be fixed to a fixing unit 30c provided on the lid portion 22. A clip, a magnet and the like may be used, for example, as the fixing unit 30c. The second supporting bar 30 is held by the lid portion 22 with the tip end side fixed to the fixing unit 30c. The tip end side of the second supporting bar 30 may also be detached from the fixing unit 30c. The second supporting bar 30 is rotatable about the coupling member 30b when the tip end side thereof is detached from the fixing unit 30c. In this case, the projection 30a may be inserted into the second supporting unit 28d by moving the tip end side of the second supporting bar 30 downward to adjust the opening amount of the lid portion 22 to the second opening amount. The second supporting bar 30 is mounted on the supporting member 28 with the projection 30a inserted into the second supporting unit 28d. When the second supporting bar 30 is mounted on the supporting member 28, the weight of the lid portion 22 is supported by the second supporting bar 30 and the supporting member 28. Therefore, the opening amount of the lid portion 22 is fixed to the second opening amount. Furthermore, the projection 30a may be removed from the second supporting unit 28d by moving the tip end side of the second supporting bar 30 upward in a state in which the projection 30a is inserted into the second supporting unit 28d. The second supporting bar 30 is detached from the supporting member 28 with the projection 30a removed from the second supporting unit 28d. In this manner, the second supporting bar 30 is detachably attached to the supporting member 28.

Although the lid portion 22 of the above-described work vehicle 1 is opened for checking a liquid surface of electrolytic solution and a state of a terminal of the battery BT and checking the tool TL and the like at the time of checkup and the like, the lid portion 22 is normally closed. For example, when the work vehicle 1 stops at night and the like, if snow falls in a state in which the lid portion 22 of the box unit 20 is closed to be unattended for a long time, snow SN might pile on the lid portion 22 (indicated by dashed-dotted line in FIGS. 5 and 6). There also is a case where sediment and the like in a site of work is deposited on the lid portion 22.

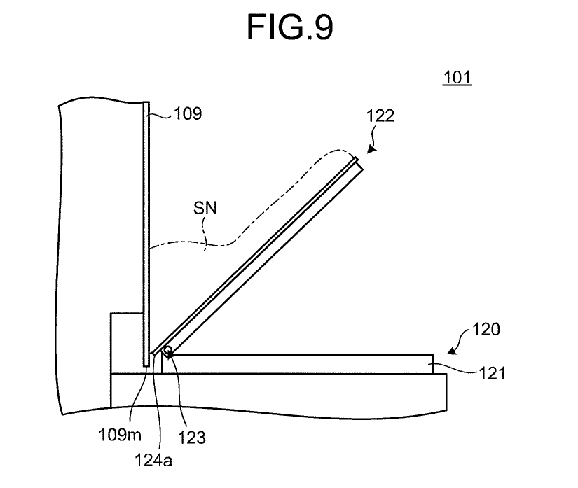

FIG. 9 is a view illustrating an example of an exterior plate 109 and a box unit 120 provided on a work vehicle 101 according to a comparative example. In the work vehicle 101 illustrated in FIG. 9, an end 109m on a lower side of the exterior plate 109 extends to a lower portion of a lid portion 122, for example. The box unit 120 includes an accommodating unit 121, the lid portion 122 which closes an inner space of the accommodating unit 121 in a closed state, and an opening/closing mechanism 123 located on the exterior plate 109 side to open/close the lid portion 122. An entire lid portion 122 has a planar shape and this is formed to be planar also regarding an end 124a on the exterior plate 109 side. In this configuration, when the lid portion 122 on which the snow SN piles is opened, for example, a space is scarcely formed between the end 109m of the exterior plate 109 and the end 124a of the lid portion 122. Therefore, the snow SN is sandwiched between the lid portion 122 and the exterior plate 109 such that the snow SN cannot escape anywhere. In this case, there is possibility that the lid portion 22 cannot be sufficiently opened. That is to say, there is possibility that the lid portion 122 cannot be opened with a sufficient open amount.

On the other hand, in this embodiment, in a state in which the lid portion 22 opens, a first space K1 is formed above the end 24a on the exterior plate 9 side of the lid portion 22 and below the exterior plate 9, as illustrated in FIG. 6. The first space K1 is formed of a part of the space K in the state in which the lid portion 22 closes, for example. The first space K1 is communicated with the above-described space K. When the first space K1 is formed, the snow SN moves to the first space K1 when the lid portion 22 is opened even when the snow SN piles on an upper surface of the lid portion 22. Therefore, the snow SN may escape to the first space K1 in the state in which the lid portion 22 is opened. That is to say, the lid portion 22 may be opened with the sufficient opening amount.

As described above, the work vehicle 1 according to this embodiment is provided with the vehicle main body 2, the exterior plate 9 covering a part of the vehicle main body 2, the accommodating unit 21 arranged around the exterior plate 9 out of the vehicle main body 2, the lid portion 22 arranged on the accommodating unit 21, the opening/closing mechanism 23 including the hinge portion 27 which couples the accommodating unit 21 to the exterior plate 9 side of the lid portion 22, the mechanism opening the lid portion 22 toward the exterior plate 9, and the first space K1 formed above the end 24a on the exterior plate 9 side of the lid portion 22 and below the exterior plate 9 in the state in which the lid portion 22 opens. In this configuration, the snow SN moves to the first space K1 when the lid portion 22 is opened even in the state in which the snow SN piles on the upper surface of the lid portion 22. Therefore, the snow SN may escape to the first space K1 in the state in which the lid portion 22 is opened. According to this, the lid portion 22 may be surely opened. Therefore, it is possible to provide the work vehicle 1 capable of surely opening the lid portion 22 of the accommodating unit 21 provided on the vehicle main body 2.

Furthermore, in the work vehicle 1 according to this embodiment, the lid portion 22 includes the extending portion 25 extending upward on the end 24a on the exterior plate 9 side and the upper end 25m of the extending portion 25 is opposed to the lower end 9m of the exterior plate 9 in the state in which the lid portion 22 closes. According to this, an excellent appearance when seen from outside may be secured.

Furthermore, in the work vehicle 1 according to this embodiment, the opening/closing mechanism 23 includes the first supporting unit 28c which supports the lid portion 22 with the first opening amount and the second supporting unit 28d which supports the lid portion 22 with the second opening amount smaller than the first opening amount. According to this, it is possible to support the lid portion 22 while switching between the first and second opening amounts.

Furthermore, in the work vehicle 1 according to this embodiment, the opening/closing mechanism 23 includes the first supporting bar 29 which supports the lid portion 22 and the second supporting bar 30 which supports the lid portion 22, and the first and second supporting bars 29 and 30 are provided separately. According to this, the first and second opening amounts may be efficiently switched.

Furthermore, in the work vehicle 1 according to this embodiment, the outer surface 25f on the plate shape portion 24 side of the extending portion 25 is flush with the outer surface 9f of the exterior plate 9. According to this, an excellent appearance when seen from outside may be secured.

Furthermore, in the work vehicle 1 according to this embodiment, the vehicle main body 2 includes the lower deck 8a on which the worker may pass, and the lid portion 22 in the closed state is used as the floor panel of the lower deck 8a. In this manner, the lid portion 22 in the closed state also serves as the floor panel of the lower deck 8a, so that a space of the vehicle main body 2 may be effectively used.

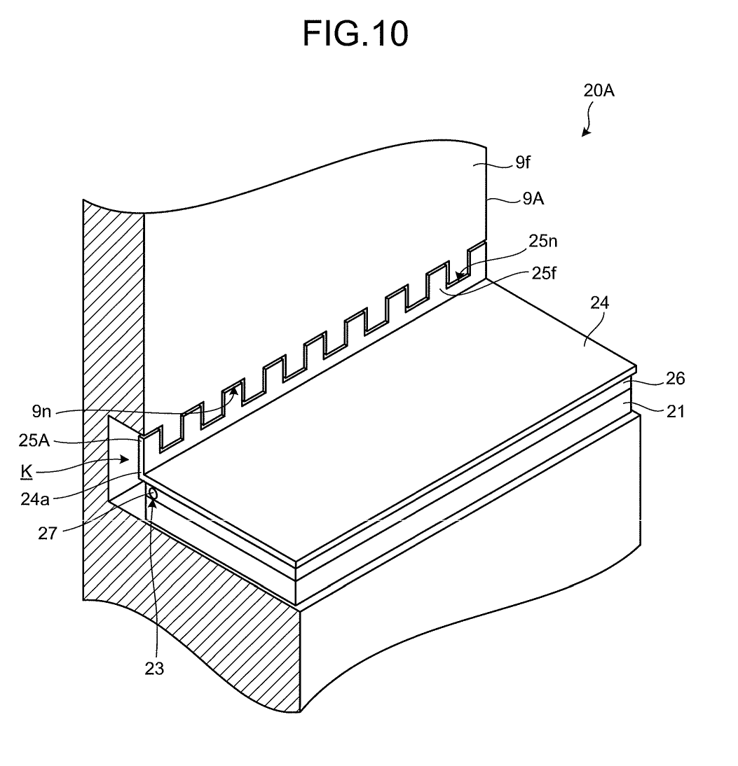

The technical scope of the present invention is not limited to the above-described embodiment and appropriate modifications may be made without departing from the gist of the present invention. For example, although a configuration in which the extending portion 25 is formed into the band shape is described as an example in the above-described embodiment, the configuration is not limited thereto. FIG. 10 is a perspective view illustrating an example of a box unit 20A according to a variation. As illustrated in FIG. 10, in the box unit 20A, an extending portion 25A and a lower end side of an exterior plate 9A may be formed to have tooth shapes. In this case, a concavo-convex portion 9n is provided on the lower end of the exterior plate 9A and a concavo-convex portion 25n having a shape corresponding to the concavo-convex portion 9n is provided on an upper end of the extending portion 25A. According to this, flexibility in design of the extending portion 25A and the exterior plate 9A is improved and an excellent appearance different from that when they are linearly arranged may be realized.

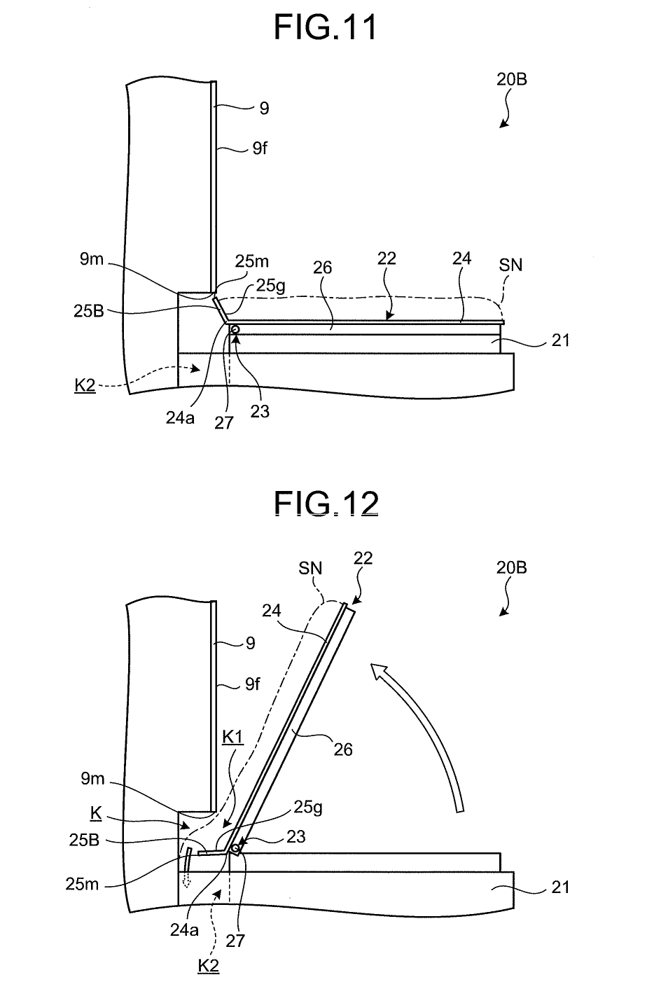

Although a configuration in which the extending portion 25 extends upward perpendicularly to the plate shape portion 24 is described as an example in the above-described embodiment, the configuration is not limited thereto. For example, FIGS. 11 and 12 are side views illustrating an example of a box unit 20B according to a variation. As illustrated in FIG. 11, an extending portion 25B of the box unit 20B extends upward from the plate shape portion 24 so as to be inclined toward the exterior plate 9. The extending portion 25B is arranged such that the upper end 25m thereof approximates the lower end 9m of the exterior plate 9. An outer surface 25g of the extending portion 25B is arranged not in parallel with but so as to be inclined from the outer surface 9f of the exterior plate 9. In this configuration, deposition such as the snow SN may be moved from the first space K1 to the space K through the extending portion 25B in the state in which the lid portion 22 is opened as illustrated in FIG. 12.

In this case, as illustrated in FIG. 12, it may also be configured such that a second space K2 which communicates the first space K1 with the ground is provided below the exterior plate 9. According to this, the deposition such as the snow SN and dirt flowing from the first space K1 to the space K may be dropped on the ground. Therefore, it becomes possible to efficiently remove the deposition on the upper surface of the lid portion 22.

Meanwhile, although the upper end 25m of the extending portion 25B is opposed to the lower end 9m of the exterior plate 9, for example, there is no limitation. For example, the upper end 25m of the extending portion 25B is not necessarily opposed to the lower end 9m of the exterior plate 9; that is to say, the upper end 25m of the extending portion 25B and the lower end 9m of the exterior plate 9 may be arranged so as to be misaligned horizontally.

Furthermore, a configuration of the extending portion 25 is not limited to that extending upward from the plate shape portion 24. For example, the extending portion 25 may be configured to extend downward from the plate shape portion 24 as long as the first space K1 is formed above the end 24a of the lid portion 22 and below the exterior plate 9 in the state in which the lid portion 22 opens.

Although a configuration in which the lid portion 22 of the box unit 20 also serves as the floor panel of the lower deck 8a is described as an example in the above-described embodiment, the configuration is not limited thereto. The lid portion 22 may also have another function or have a dedicated configuration for covering the opening of the accommodating unit 21, for example.

Although a configuration in which the first supporting bar 29 and the second supporting bar 30 are provided separately in the opening/closing mechanism 23 is described as an example in the above-described embodiment, the configuration is not limited thereto. For example, it is also possible to configure such that the opening amount of the lid portion 22 is adjusted only by using the first supporting bar 29 by providing a locking unit corresponding to the second supporting unit 28d on a moving route of the first supporting bar 29 of the supporting member 28.

### REFERENCE SIGNS LIST

K Space
K1 First space
K2 Second space
BT Battery
TL Tool
SN Snow
1 Work vehicle
2 Vehicle main body
3 Driver's cabin
4 Travel device
5 Wheel
5F Front wheel
5R Rear wheel
6 Tire
6F Front tire
6R Rear tire
8 Vehicle body frame
8a Lower deck
8b Upper deck
8c Ladder
8d Oblique ladder
8e Handrail
9, 9A Exterior plate
9f, 25f, 25g Outer surface
9m Lower end
9n, 25n Concavo-convex portion
10 Working machine
11 Boom
12 Bucket
15 Bell crank
20, 20A, 20B Box unit
21 Accommodating unit
22 Lid portion
23 Opening/closing mechanism
24 Plate shape portion
24a End
25, 25A, 25B Extending portion
25m Upper end
26 Attaching margin
27 Hinge portion
28 Supporting member
28a Standard locking unit
28b Guiding unit
28c First supporting unit
28d Second supporting unit
29 First supporting bar
29a, 30a Projection
29c, 30b Coupling member
29c Coupling unit
30 Second supporting bar

1. A work vehicle, comprising:
a vehicle main body;
an exterior plate which covers a part of the vehicle main body;
an accommodating unit arranged around the exterior plate of the vehicle main body;
a lid portion configured to close an inner space of the accommodating unit; and
an opening/closing mechanism which couples the accommodating unit to the lid portion and is located on a side of an exterior plate to open/close the lid portion,
wherein a first space is formed above an end on the side of the exterior plate of the lid portion and below the exterior plate in a state in which the lid portion opens.

2. The work vehicle according to claim 1, wherein
the lid portion includes an extending portion extending upward on the end on the side of the exterior plate, and
an upper end of the extending portion is opposed to a lower end of the exterior plate in a state in which the lid portion closes.

3. The work vehicle according to claim 1, wherein a second space is arranged below the exterior plate to communicate the first space with the ground.

4. The work vehicle according to claim 1, wherein
the opening/closing mechanism includes a first supporting unit which supports the lid portion with a first opening amount, and a second supporting unit which supports the lid portion with a second opening amount smaller than the first opening amount.

5. The work vehicle according to claim 4, wherein
the opening/closing mechanism includes a first supporting bar which supports the lid portion and a second supporting bar which supports the lid portion, and
the first and second supporting bars are provided separately.

6. The work vehicle according to claim 1, wherein
an outer surface of the extending portion is arranged flush with an outer surface of the exterior plate.

7. The work vehicle according to claim 1, wherein
the vehicle main body includes a deck, and the lid portion in a closed state is used as a floor panel of the deck.
